(19) United States
(12) Patent Application Publication
(10) Pub. No.: US 2015/0334265 A1
(43) Pub. Date: Nov. 19, 2015

(54) PRINT SYSTEM, CONTROLLER, PRINTER, AND NON-TRANSITORY COMPUTER READABLE MEDIUM

(71) Applicant: FUJI XEROX CO., LTD., TOKYO (JP)

(72) Inventors: Kazuhide KOBAYASHI, Kanagawa (JP); Hiroshi SHIOTA, Kanagawa (JP); Masateru HATTORI, Kanagawa (JP); Takayuki MATSUI, Kanagawa (JP); Satoshi KONDO, Kanagawa (JP)

(73) Assignee: FUJI XEROX CO., LTD., TOKYO (JP)

(21) Appl. No.: 14/547,767

(22) Filed: Nov. 19, 2014

(30) Foreign Application Priority Data
May 15, 2014 (JP) 2014-101432

(51) Int. Cl. H04N 1/23

(52) U.S. Cl. CPC H04N 1/233; H04N 2201/3212

(57) ABSTRACT

A print system includes a controller and a printer. The controller transmits image data of an image in which pixels are arranged in a main scanning direction and a subscanning direction, and transmits subscanning-direction line information which is information about a predetermined subscanning-direction line. The printer expands the image data transmitted from the controller into print data for printing, and extracts extraction information in the subscanning direction from the print data so as to compare the subscanning-direction line information with the extraction information. The extraction information corresponds to the transmitted subscanning-direction line information.

### CROSS-REFERENCE TO RELATED APPLICATIONS

This application is based on and claims priority under 35 USC 119 from Japanese Patent Application No. 2014-101432 filed May 15, 2014.

### BACKGROUND

### Technical Field

The present invention relates to a print system, a controller, a printer, and a non-transitory computer readable medium.

### SUMMARY

According to an aspect of the invention, there is provided a print system including a controller and a printer. The controller transmits image data of an image in which pixels are arranged in a main scanning direction and a subscanning direction, and transmits subscanning-direction line information which is information about a predetermined subscanning-direction line. The printer expands the image data transmitted from the controller into print data for printing, and extracts extraction information in the subscanning direction from the print data so as to compare the subscanning-direction line information with the extraction information. The extraction information corresponds to the transmitted subscanning-direction line information.

### BRIEF DESCRIPTION OF THE DRAWINGS

Exemplary embodiment of the present invention will be described in detail based on the following figures, wherein:

FIG. 1 is a diagram illustrating an overall configuration of a print system according to an exemplary embodiment of the present invention;

FIG. 2 is a diagram illustrating a printer;

FIG. 3 is a flowchart of an exemplary process flow performed by a controller;

FIG. 4 is a diagram illustrating a state of image data;

FIGS. 5A and 5B are diagrams for describing management information;

FIG. 6 is a flowchart of a process flow on the printer side;

FIG. 7 is a diagram illustrating an image artifact on continuous paper;

FIGS. 8A and 8B are diagrams for describing the number of subscanning-direction lines; and

FIG. 9 is a diagram illustrating a print system which forms a color image.

### DETAILED DESCRIPTION

Referring to the attached drawings, an exemplary embodiment of the present invention will be described.

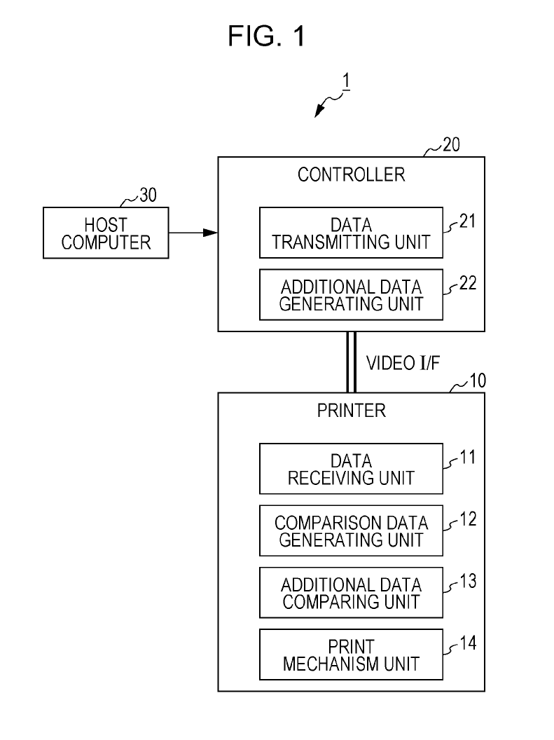

FIG. 1 is a diagram illustrating an overall configuration of a print system according to the exemplary embodiment of the present invention.

A print system 1 according to the exemplary embodiment includes a printer 10 which performs printing (image formation) on a sheet of paper, a controller (control apparatus) 20 which controls the printer 10, and a host computer 30 which transmits data to the controller 20.

The controller 20 includes a central processing unit (CPU), a read only memory (ROM), and a random access memory (RAM) which are not illustrated.

The ROM stores control programs executed by the CPU. The CPU reads the control program stored in the ROM, and executes the control programs by using the RAM as a work area. The CPU executing the control programs causes the controller 20 to function as a data transmitting unit 21, an additional data generating unit 22, and the like. The role of the additional data generating unit 22 will be described below.

The printer 10 includes a data receiving unit 11, a comparison data generating unit 12, an additional data comparing unit 13, and a print mechanism unit 14.

The print mechanism unit 14 performs printing on a sheet which is exemplary recording material. The print mechanism unit 14 transfers a toner image on a photoconductor drum to a sheet as described below, thereby performing printing on the sheet. Printing on a sheet may be performed by using an inkjet method or the like.

The comparison data generating unit 12 and the additional data comparing unit 13 which are achieved, for example, by using the CPU executing predetermined control programs generate second line data (described below) and compare first line data (described below) with the second line data.

The control programs executed by the controller 20 or the printer 10 may be provided by storing the control programs in a computer-readable recording medium, such as a magnetic recording medium, e.g., a magnetic tape or a magnetic disk, an optical recording medium, e.g., an optical disk, a magneto-optical recording medium, or a semiconductor memory. A communication system such as the Internet is used to download the control programs to the controller 20 or the printer 10.

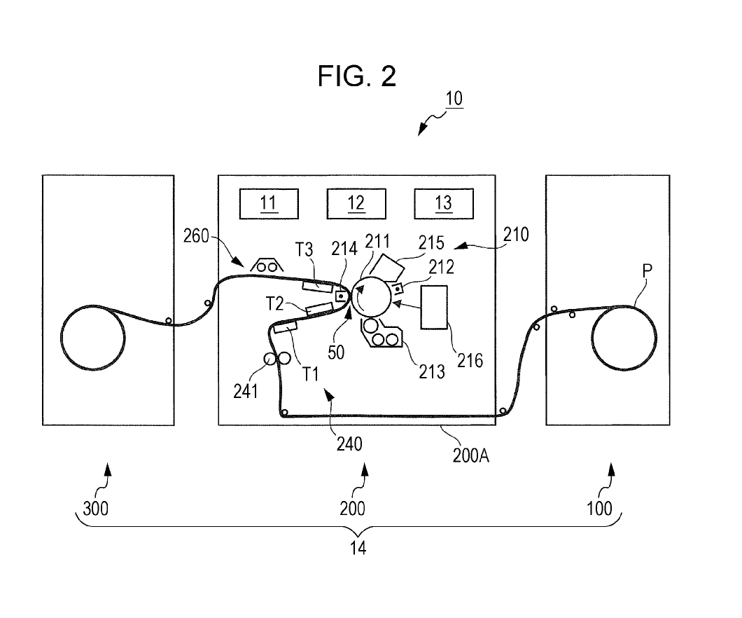

FIG. 2 is a diagram illustrating the printer 10.

As illustrated in FIG. 2, the printer 10 according to the exemplary embodiment includes the data receiving unit 11, the comparison data generating unit 12, the additional data comparing unit 13, and the print mechanism unit 14, as described above.

The print mechanism unit 14 includes a sheet feeder 100 which feeds continuous paper P, a print unit 200 which performs printing on the continuous paper P supplied from the sheet feeder 100, and a take-up unit 300 which takes up the continuous paper P which has passed through the print unit 200. In the printer 10, the continuous paper P with feed holes (sprocket holes) and the continuous paper P without feed holes may be used.

The print unit 200 includes an image forming unit 210 which forms an image in accordance with received image data. The print unit 200 also includes a sheet conveying unit 240 which functions as a conveying unit conveying the continuous paper P which has been conveyed, via the image forming unit 210. In addition, the print unit 200 includes a fixing device 260 which has, for example, a flash lamp and which fixes a toner image formed on the continuous paper P.

The image forming unit 210 includes a photoconductor drum 211 on which an electrostatic latent image is formed while the photoconductor drum 211 rotates in the direction indicated by an arrow in FIG. 2, a charger 212 which charges the surface of the photoconductor drum 211, and a developing device 213 which develops the electrostatic latent image formed on the photoconductor drum 211 by using toner.

In addition, the image forming unit 210 includes a transfer device 214 which transfers a toner image formed on the photoconductor drum 211 to the continuous paper P. According to the exemplary embodiment, a portion in which the photoconductor drum 211 faces the transfer device 214 constitutes a transfer portion 50. In the transfer portion 50, a toner image on the photoconductor drum 211 is transferred to the continuous paper P.

The image forming unit 210 includes a drum cleaner 215 which cleans the surface of the photoconductor drum 211 after transfer. In addition, the image forming unit 210 includes a laser exposure device 216 which exposes the photoconductor drum 211. The laser exposure device 216 scans and exposes the photoconductor drum 211 by using laser light whose illumination is controlled on the basis of the obtained image data.

The sheet conveying unit 240 includes back tension rollers 241 which are provided in such a manner as to be capable of rotating in the reverse direction and which are used to convey the continuous paper P to the image forming unit 210. Downstream of the back tension rollers 241, aligning rollers (not illustrated) are disposed.

A guide wall (not illustrated) which guides the continuous paper P is disposed on the front side in an apparatus body 200A and in the conveying direction of the continuous paper P. When the pinless continuous paper P is conveyed, the aligning rollers are used to position the continuous paper P by pushing the continuous paper P to the guide wall.

In the sheet conveying unit 240, a first tractor feeder T1 and a second tractor feeder T2 which convey the pinfeed continuous paper P to the transfer portion 50 are disposed downstream of the back tension rollers 241 in the conveying direction of the continuous paper P. In addition, a third tractor feeder T3 which conveys the pinfeed continuous paper P which has passed through the transfer portion 50 to the fixing device 260 is disposed.

In the printer 10, the continuous paper P is supplied from the sheet feeder 100 to the print unit 200. The continuous paper P is conveyed to the transfer portion 50 by using the back tension roller 241, the first tractor feeder T1, the second tractor feeder T2, and the like.

In the print unit 200, image data is supplied to the laser exposure device 216. The surface of the photoconductor drum 211 charged by the charger 212 is scanned and exposed by using laser light whose illumination is controlled by the laser exposure device 216, whereby an electrostatic latent image is formed on the photoconductor drum 211.

The formed electrostatic latent image is developed by the developing device 213, and a toner image is formed on the photoconductor drum 211. The toner image is transferred onto the continuous paper P by the transfer device 214. After that, the continuous paper P onto which the toner image is transferred is conveyed to the fixing device 260. The toner image on the continuous paper P which has not been fixed is subjected to a thermal fixing process by the fixing device 260 so as to be fixed on the continuous paper P. Then, the continuous paper P is discharged from the print unit 200, and is taken up by the take-up unit 300.

In the printer 10, a missing bit or the like in image data may cause print misregistration. In the exemplary embodiment, a process for suppressing the print misregistration is performed. The process for suppressing the print misregistration will be described below.

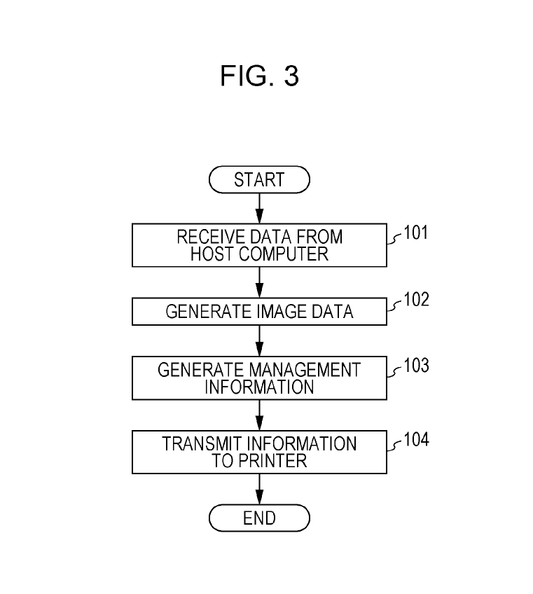

FIG. 3 is a flowchart of an exemplary process flow performed by the controller 20.

The controller 20 first receives data described, for example, in a page description language (PDL) from the host computer 30 (in step 101). Then, the controller 20 uses the data to generate image data (in step 102).

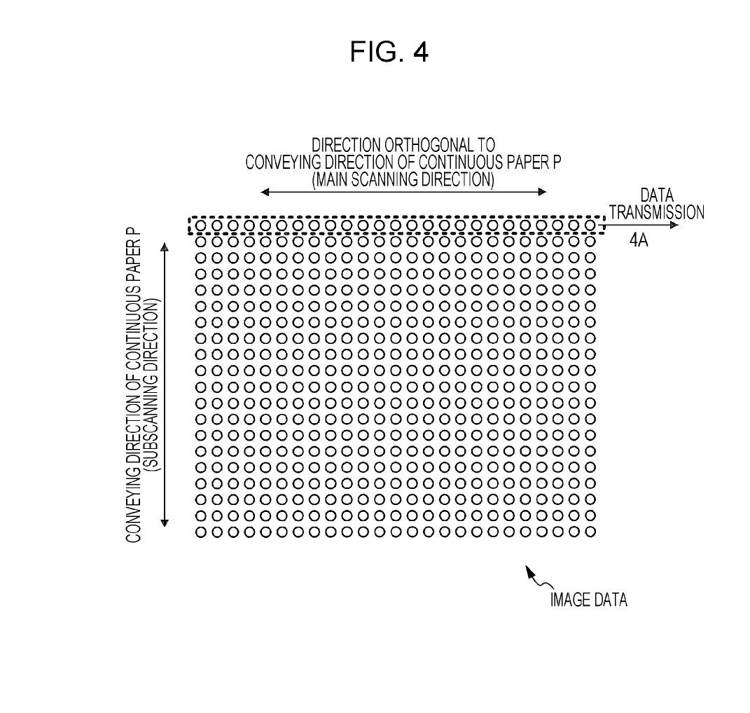

Specifically, the above-described data is subjected to rendering (expansion for drawing), and image data (bit map data) represented by pixel data arrayed in a matrix is generated as illustrated in FIG. 4 (diagram illustrating the state of the image data). In FIG. 4, the vertical direction represents the conveying direction of the continuous paper P (subscanning direction), and the horizontal direction represents the direction orthogonal to the conveying direction of the continuous paper P (main scanning direction).

Referring to FIG. 3, the process will be further described.

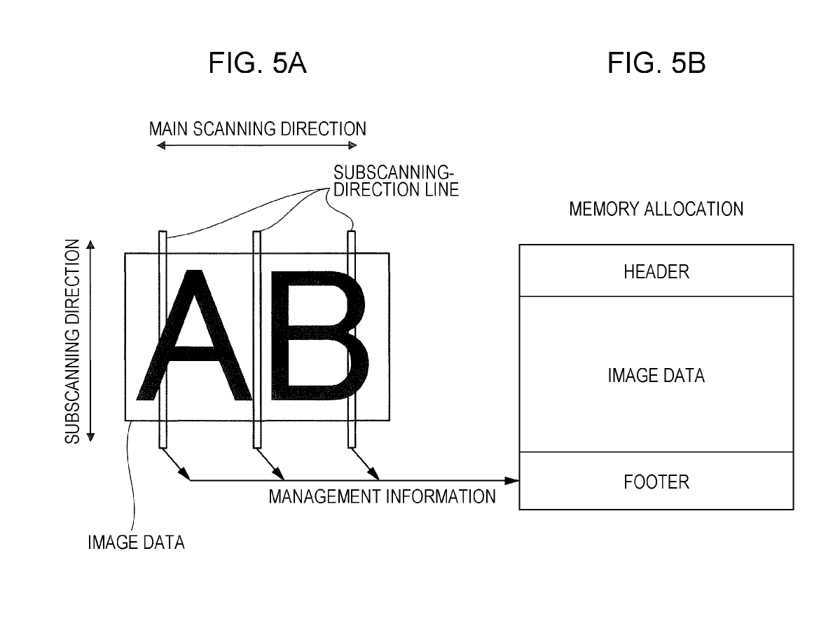

Then, the controller 20 generates management information (in step 103). Referring to FIGS. 5A and 5B (diagrams for describing the management information), the management information will be described.

FIG. 5A is a diagram which schematically illustrates the image data illustrated in FIG. 4. When the management information is to be generated, the additional data generating unit 22 which functions as an acquiring unit obtains subscanning-direction line information which is information about predetermined subscanning-direction lines. Specifically, the additional data generating unit 22 obtains image data (hereinafter referred to as “first line data”) located on the subscanning-direction lines which are lines in the subscanning direction, from the image data.

The number of subscanning-direction lines is more than one. In the exemplary embodiment, multiple pieces of first line data are obtained. In the exemplary embodiment, the line column numbers which are information about the positions of the subscanning-direction lines (positions in the main scanning direction) are obtained as the management information. Further, information about the number of lines is obtained.

That is, in the exemplary embodiment, pieces of information about the first line data (exemplary subscanning-direction line information), the line column numbers, and the number of lines are obtained as the management information. These pieces of information are temporarily stored in a memory provided in the controller 20. Specifically, the pieces of information are stored in the footer as illustrated in FIG. 5B.

Referring to FIG. 3 again, the process will be further described.

After the process in step 103 is performed (after generation of the management information), in the exemplary embodiment, the data transmitting unit 21 of the controller 20 which achieves a transmitting function transmits the information to the printer 10 in step 104. Specifically, the information stored in the memory (see FIG. 5B) in the controller 20 is transmitted to the printer 10. More specifically, the image data and the management information are transmitted to the printer 10. At that time, the management information which is attached to the footer is transmitted.

In transmission of the information from the controller 20 to the printer 10, serial output is performed, and pieces of pixel data are output one by one. In addition, in transmission of the information, image data of a first line in the main scanning direction is first transmitted as illustrated by using a reference character 4A in FIG. 4. Then, image data of the next line adjacent to the first line is transmitted.

Put another way, in the exemplary embodiment, transmission of image data included in a first line in the main scanning direction and transmission of image data included in the next line adjacent to the first line are sequentially performed, and all of the image data is transmitted. In other words, in the exemplary embodiment, data transmission of a first line in the main scanning direction is performed. Upon completion of transmission of the image data of the first line, transmission of image data of the next line adjacent the first line is performed.

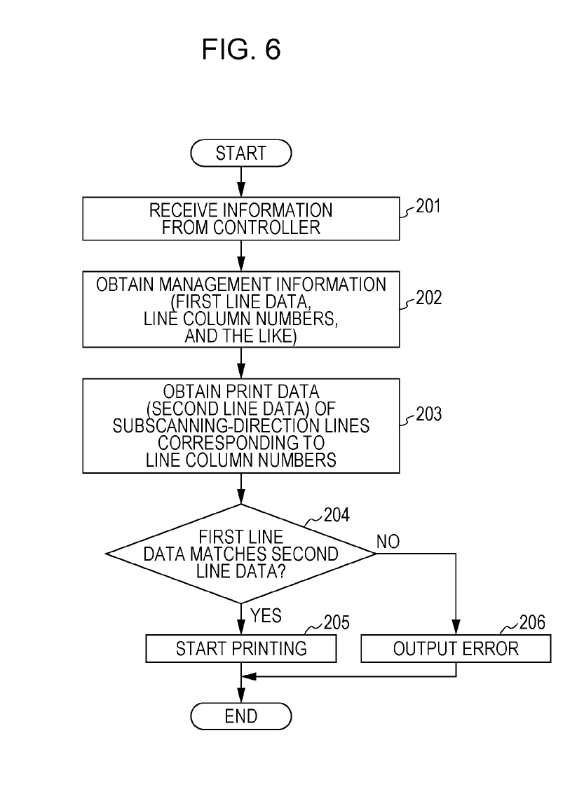

FIG. 6 is a flowchart of a process flow on the printer 10 side.

In the printer 10, the data receiving unit 11 which functions as a receiving unit first receives the information from the controller 20 (in step 201).

Then, in the exemplary embodiment, the image data in the received information is stored in a state in which the image data is loaded in a memory (hereinafter referred to as a “printer memory”) in the printer 10. Put another way, the image data is stored in the same state as that illustrated in FIG. 4.

In other words, in the exemplary embodiment, image data which is sequentially transmitted from the controller 20 is stored in a state in which the image data is loaded in the printer memory, whereby a matrix data which is suitable for the print process performed by the print mechanism unit 14 is obtained (the image data after storing in the printer memory may be hereinafter referred to as “print data” in the specification).

In the exemplary embodiment, the comparison data generating unit 12 obtains the management information (the first line data, the line column numbers, and the number of lines) from the footer in the information received by the data receiving unit 11 (in step 202).

After that, the comparison data generating unit 12 which functions as a part of a comparing unit obtains (extracts) print data (hereinafter referred to as second line data) of the subscanning-direction lines corresponding to the line column numbers from the print data stored in the printer memory (in step 203). Put another way, in step 203, line data in the subscanning direction which corresponds to the first line data is extracted from the print data stored in the printer memory.

Then, the additional data comparing unit 13 which functions as a part of the comparing unit determines whether or not the first line data (the first line data, the subscanning-direction line information included in the management information) which is transmitted from the controller 20 matches the second line data (extraction information) in step 204.

If it is determined that the first line data matches the second line data, the print process performed by the print mechanism unit 14 is started (in step 205). In contrast, if it is determined that the first line data does not match the second line data, the print process performed by the print mechanism unit 14 is stopped, and a signal indicating that an error occurs is transmitted from the printer 10 to the controller 20 (in step 206). An error is displayed on the controller 20 or the host computer 30.

During transmission of image data from the controller 20 to the printer 10, for example, when a bit is missing, an artifact occurs in the image data in such a manner that print misregistration occurs or that a part of the image data is missing. To address this situation, the configuration according to the exemplary embodiment enables an artifact in image data to be detected. Thus, the likelihood of printing in a state in which print misregistration occurs and printing in a state in which a part of a print image is missing is reduced. Put another way, the likelihood of printing in a state different from that intended by a user is reduced.

In the exemplary embodiment, the management information is added to the footer, not to the body of the image data. Thus, the likelihood of occurrence of an artifact or the like in an image which is caused by the management information is reduced. When the management information is added to the body of the image data, an image based on the management information may be formed on the continuous paper P. In the exemplary embodiment, the case in which the management information is added to the footer is described as an example. This is merely an example, and the management information may be added to the header, or may be added to both of the header and the footer.

In the exemplary embodiment, the configuration is provided in which line data in the subscanning direction (vertical direction) is obtained. Thus, compared with the case in which line data in the main scanning direction (horizontal direction) is obtained, accuracy of detecting an image artifact is improved.

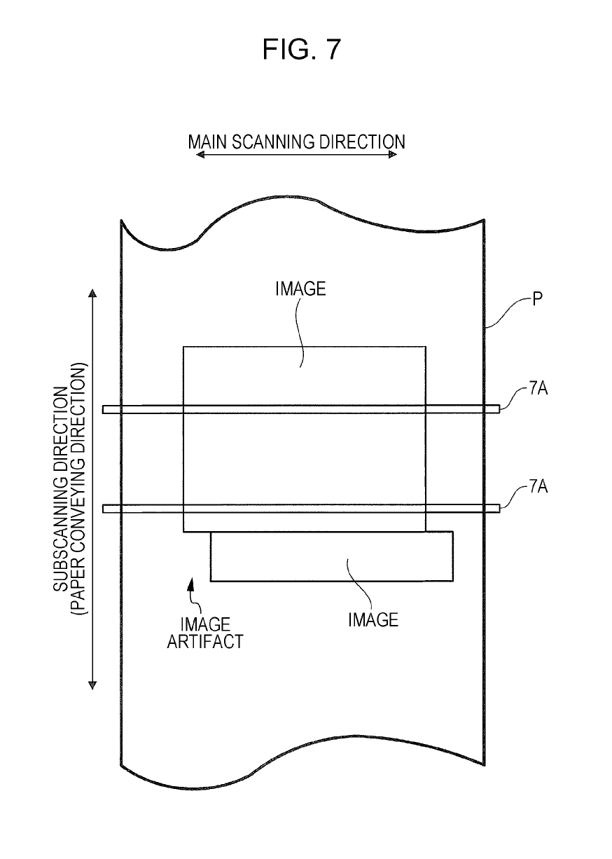

When a bit is missing, an image artifact may occur in the middle of an image on the continuous paper P as illustrated in FIG. 7 (diagram illustrating an image artifact on the continuous paper P). Specifically, as illustrated in FIG. 7, print misregistration may occur in the middle of the image, and a part of an image may be shifted in the main scanning direction.

In this state, as illustrated by using reference characters 7A, when pieces of line data in the main scanning direction are obtained, the shift in this image fails to be detected. In contrast, in the exemplary embodiment, pieces of line data in the subscanning direction are obtained, enabling such a shift in the image to be detected.

As another exemplary configuration, image data may be transmitted on a band-by-band basis from the controller 20 to the printer 10. Further, pieces of image data on a band-by-band basis may be stored in the printer memory of the printer 10 in a state in which the pieces of image data are arranged in the subscanning direction. The image data on a band-by-band basis represents each piece of image data obtained by dividing the image data on the basis of a predetermined size.

Even in the case where pieces of image data on a band-by-band basis are stored in the printer memory of the printer 10 in a state in which the pieces of image data are arranged in the subscanning direction, similarly to the above-described case, misregistration of image data (a shift in the main scanning direction or a shift on a band-by-band basis in the image data) may occur in the middle of the image in the subscanning direction. In this case, similarly to the above-described case, when line image in the main scanning direction is obtained, this shift in the image is unlikely to be detected. In contrast, when line data in the subscanning direction is obtained, the shift in the image is detected.

A method of the related art in which print misregistration is detected will be described.

An example of the method of the related art is a method in which an identification code is added to a portion of each page. This method fails to detect print misregistration in a part of an image or a missing part of an image. Another example is a method in which a sum value is calculated for each of the lines in the main scanning direction and in which the sum value is added to the line. In this case, the processing efficiency is low. In addition, in this case, data other than image data is added to the image data, which may cause the data other than the image data to be printed.

Another processing example will be described.

The case in which the number of subscanning-direction lines (first line data) is constant (a fixed value) is described above. The present invention is not limited to this. For example, the number of subscanning-direction lines may be increased or decreased in accordance with the conveying speed of the continuous paper P in the printer 10.

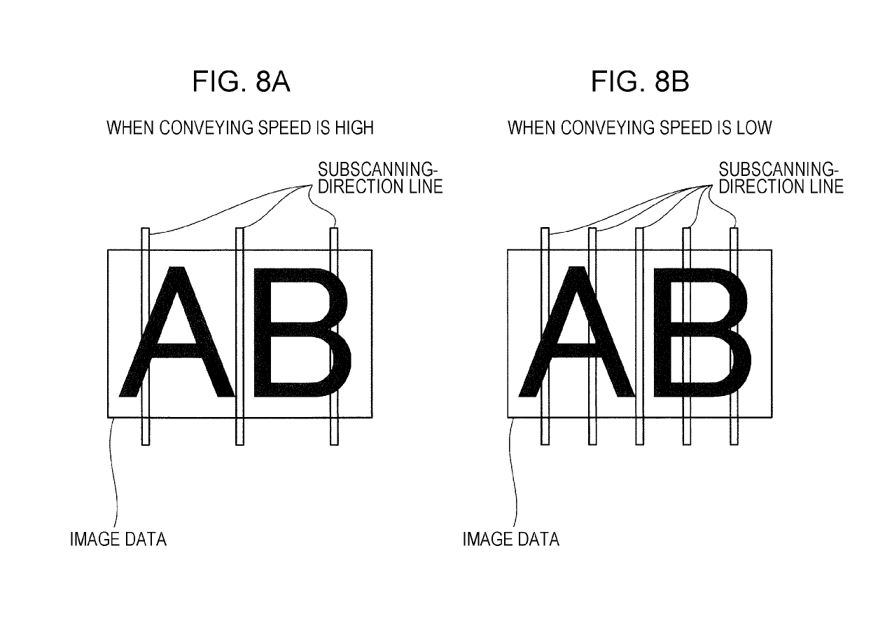

Specifically, as illustrated in FIGS. 8A and 8B (diagrams for describing the number of subscanning-direction lines), when the conveying speed of the continuous paper P is lower than a predetermined conveying speed, it is desirable that the number of subscanning-direction lines be increased compared with the case in which the conveying speed of the continuous paper P is higher than the predetermined conveying speed. When the conveying speed of the continuous paper P is low, more time for the above-described processing on line data is allowed. Therefore, the number of subscanning-direction lines may be increased. In this case, accuracy in determination as to whether or not print misregistration occurs is further improved.

The case in which a part of image data itself is obtained as the first line data and the second line data and in which pieces of image data are compared with each other is described above as an example. Instead of image data itself, for example, sum values obtained by summing the data value of each pixel may be obtained, and the sum values may be compared with each other.

Further, the case in which the line column numbers which are position information of the subscanning-direction lines are transmitted from the controller 20 to the printer 10 is described above as an example. When the line column numbers are predetermined in the controller 20 and the printer 10, transmission of the line column numbers from the controller 20 to the printer 10 may be skipped.

Furthermore, the print system which performs printing on the continuous paper P is described above as an example. Each of the configurations and the processes which are described above is not limited to that for the continuous paper P, and may be applied to a print system which performs printing on cut-sheet paper.

The print system 1 which forms a single-color image, for example, by using black is described above. Each of the above-described configurations may be applied to the print system 1 which forms a color image.

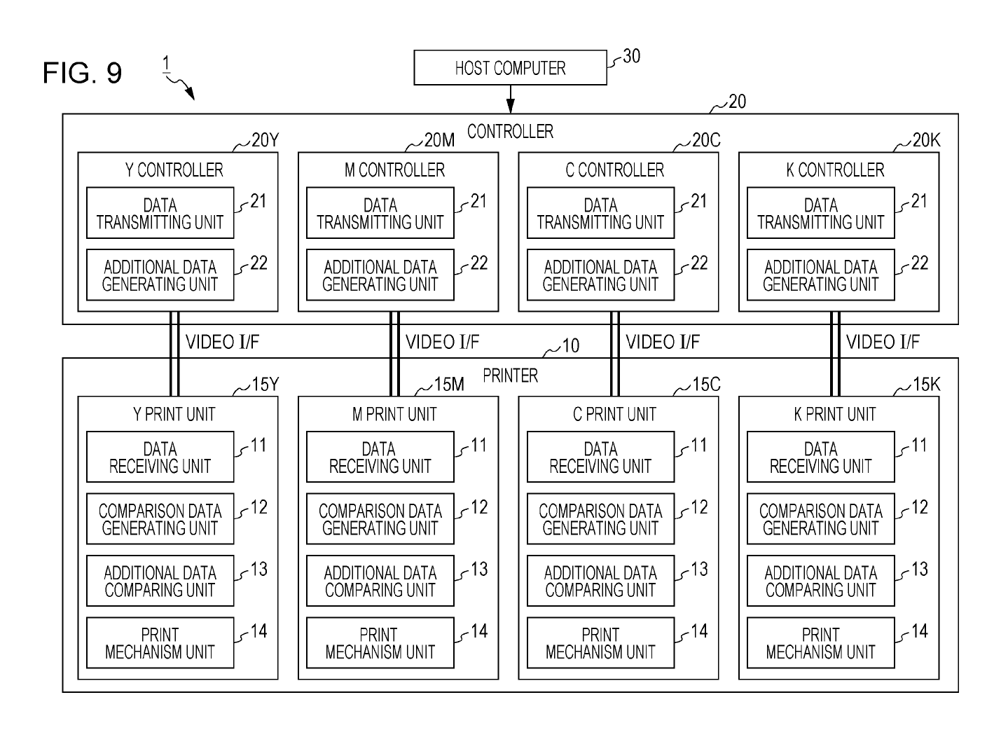

In the print system 1 which forms a color image, for example, as illustrated in FIG. 9 (diagram illustrating the print system 1 which forms a color image), the printer 10 includes four print units, i.e., a Y print unit 15Y, an M print unit 15M, a C print unit 15C, and a K print unit 15K.

The Y print unit 15Y forms a yellow (Y) image; the M print unit 15M, a magenta (M) image; the C print unit 15C, a cyan (C) image; and the K print unit 15K, a black (K) image. Each of the Y print unit 15Y, the M print unit 15M, the C print unit 15C, and the K print unit 15K includes the data receiving unit 11, the comparison data generating unit 12, the additional data comparing unit 13, and the print mechanism unit 14 as described above.

In contrast, the controller 20 includes a Y controller 20Y, an M controller 20M, a C controller 20C, and a K controller 20K which correspond to the Y print unit 15Y, the M print unit 15M, the C print unit 15C, and the K print unit 15K, respectively. Each of the Y controller 20Y, the M controller 20M, the C controller 20C, and the K controller 20K includes the data transmitting unit 21 and the additional data generating unit 22.

Each of the Y controller 20Y, the M controller 20M, the C controller 20C, and the K controller 20K generates the first line data for a corresponding one of the colors. Each of the Y print unit 15Y, the M print unit 15M, the C print unit 15C, and the K print unit 15K generates the second line data for a corresponding one of the colors. In the exemplary embodiment, each of the Y print unit 15Y, the M print unit 15M, the C print unit 15C, and the K print unit 15K compares the first line data with the second line data.

The number of pieces of first line data and second line data generated for each of yellow (Y), magenta (M), cyan (C), and black (K) may be the same, or the number of pieces of first line data and second line data generated for one color may be different from that for another color. For example, for one of yellow (Y), magenta (M), cyan (C), and black (K), i.e., for a selected color, the number of pieces of first line data and second line data is increased, while, for the other colors, the number of pieces of first line data and second line data is decreased so as to be smaller than that for the selected color.

More specifically, for example, for a color for which the amount of image data is smaller than a predetermined amount among yellow (Y), magenta (M), cyan (C), and black (K), the number of pieces of first line data and second line data is increased. In this case, without reducing print efficiency, accuracy in detection of print misregistration or the like is improved for an image using a color for which the amount of image data is small.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A print system comprising:
a controller that transmits image data of an image in which pixels are arranged in a main scanning direction and a subscanning direction, and that transmits subscanning-direction line information which is information about a predetermined subscanning-direction line; and
a printer that expands the image data transmitted from the controller into print data for printing, and that extracts extraction information in the subscanning direction from the print data so as to compare the subscanning-direction line information with the extraction information, the extraction information corresponding to the transmitted subscanning-direction line information.

2. The print system according to claim 1,
wherein the printer performs printing on recording material, and the printer includes a conveying unit which conveys the recording material, and
wherein, when a conveying speed of the recording material in the printer is lower than a predetermined conveying speed, compared with a case in which the conveying speed of the recording material in the printer is higher than the predetermined conveying speed, the controller increases the number of subscanning-direction lines for obtaining the subscanning-direction line information.

3. The print system according to claim 1,
wherein, when the image data and the subscanning-direction line information are to be transmitted, the controller adds the subscanning-direction line information to a header or a footer, and transmits the image data and the subscanning-direction line information.

4. The print system according to claim 2,
wherein, when the image data and the subscanning-direction line information are to be transmitted, the controller adds the subscanning-direction line information to a header or a footer, and transmits the image data and the subscanning-direction line information.

5. A controller comprising:
an acquiring unit that acquires subscanning-direction line information which is information about a predetermined subscanning-direction line, from image data of an image in which pixels are arranged in a main scanning direction and a subscanning direction; and
a transmitting unit that transmits the image data and the subscanning-direction line information acquired by the acquiring unit to a printer.

6. A printer comprising:
a receiving unit that receives image data of an image in which pixels are arranged in a main scanning direction and a subscanning direction, and that receives subscanning-direction line information which is information about a predetermined subscanning-direction line; and
a comparing unit that expands the image data received by the receiving unit into print data for printing, and that extracts extraction information in the subscanning direction from the print data so as to compare the subscanning-direction line information with the extraction information, the extraction information corresponding to the subscanning-direction line information received by the receiving unit.

7. A non-transitory computer readable medium storing a program causing a computer to execute a process comprising:
acquiring subscanning-direction line information which is information about a predetermined subscanning-direction line, from image data of an image in which pixels are arranged in a main scanning direction and a subscanning direction; and
transmitting the image data and the acquired subscanning-direction line information to a printer.

8. A non-transitory computer readable medium storing a program causing a computer to execute a process comprising:
receiving image data of an image in which pixels are arranged in a main scanning direction and a subscanning direction, and receiving subscanning-direction line information which is information about a predetermined subscanning-direction line; and
expanding the received image data into print data for printing, and extracting extraction information in the subscanning direction from the print data so as to compare the subscanning-direction line information with the extraction information, the extraction information corresponding to the received subscanning-direction line information.
